(19) United States
(12) Patent Application Publication
(10) Pub. No.: US 2024/0033848 A1
(43) Pub. Date: Feb. 1, 2024

(54) METHOD FOR WELDING METAL-CONTAINING, BENT BAR-TYPE CONDUCTORS, WITH INTENSITY REDISTRIBUTION IN AN INITIAL PHASE AND AN END PHASE

(71) Applicant: TRUMPF Laser- und Systemtechnik GmbH, Ditzingen (DE)

(72) Inventors: Oliver Bocksrocker, Sachsenheim (DE); Nicolai Speker, Pleidelsheim (DE); Tim Hesse, Ditzingen (DE)

(21) Appl. No.: 18/484,471

(22) Filed: Oct. 11, 2023

Related U.S. Application Data
(63) Continuation of application No. PCT/EP2022/059211, filed on Apr. 7, 2022.

(30) Foreign Application Priority Data
Apr. 16, 2021 (DE) 10 2021 109 622.7

(51) Int. Cl. B23K 26/06; B23K 26/244; B23K 26/073; H02K 15/04

(52) U.S. Cl. CPC B23K 26/0626; B23K 26/244; B23K 26/0734; H02K 15/0414; B23K 2101/38

(57) ABSTRACT

A method for welding bar-type conductors includes arranging at least two bar-type conductors in partially overlapping fashion, and welding the at least two bar-type conductors to one another by using a processing laser beam. The processing laser beam traverses a welding contour relative to the bar-type conductors. The traversing of the welding contour includes an initial phase, a main phase and an end phase. In the initial phase, in a partial region of a beam cross section of the processing laser beam, an intensity of the processing laser beam, which is spatially averaged over the partial region, is increased over time. In the main phase, the spatially averaged intensity, which is achieved at the end of the initial phase, is kept at least substantially constant over time. In the end phase, the spatially averaged intensity, starting from the intensity at the end of the main phase, is reduced over time.

### CROSS REFERENCE TO RELATED APPLICATIONS

This application is a continuation of International Application No. PCT/EP2022/059211 (WO 2022/218796 A2), filed on Apr. 7, 2022, and claims benefit to German Patent Application No. DE 10 2021 109 622.7, filed on Apr. 16, 2021. The aforementioned applications are hereby incorporated by reference herein.

### FIELD

Embodiments of the present invention relate to a method for welding metal-containing, bent bar-type conductors.

### BACKGROUND

A method has been disclosed in the published German patent application DE 102020113179.8.

In the manufacture of electric motors or electronic generators, in addition to wound stators use is also made nowadays of stators which are formed from metallic, bar-shaped conductors (“bar-type conductors”), in particular what are referred to as hairpins. The bar-type conductors are arranged such that they correspond to an intended electrical connection and are then welded to one another in order to form an electromagnet in this way. By contrast to the wound stator, the hairpin technology enables advantages in terms of weight, costs and efficiency.

The bar-type conductors are frequently welded using a laser beam. To that end, the laser beam is typically directed at the front end faces of at least two overlapping bar-type conductors that generally lie against one another. As a result, heat is introduced into the bar-type conductors, the bar-type conductors melt and, after solidifying, the bar-type conductors are connected to one another via a solidified weld bead.

An example for the welding of copper-containing bar-type conductors has been disclosed in the subsequently published German patent application 10 2020 113 179.8. For this purpose, a processing laser beam is directed at the end regions of two copper-containing bar-type conductors lying against one another, said processing laser beam traversing the end surfaces repeatedly in a circular welding contour. In the vicinity of the end surfaces, the material of the bar-type conductors is melted by the action of the processing laser beam and a weld bead is formed. At the end of welding, after the action of the processing laser beam, the molten material of the bar-type conductors solidifies, and the bar-type conductors are connected to one other via a solidified weld bead.

Important factors when welding bar-type conductors include short process times (also called time per part) and the avoidance of process errors, such as spatter formation at the beginning and pore formation at the end of the welding of the bar-type conductors. In addition, a sufficiently large cross-sectional area, through which the electrical current can flow between the at least two bar-type conductors, has to be produced during the welding. If the welding is not performed correctly, ohmic heating, a loss of effectiveness or an unusable electrodynamic machine can arise during operation.

Short process times for the welding of copper-containing bar-type conductors can be achieved, for example, by a high laser power of an NIR laser beam (NIR SingleSpot laser) of high brilliance. However, at high laser powers, a large number of spatters are formed, especially at the beginning of the welding, and a large number of pores are formed, especially in the second half of the welding. This reduces the quality of the welding of the bar-type conductors and, in the worst case, renders them unusable.

Bocksrocker et al., “Reduction of spatters and pores in laser welding of copper hairpins using two superimposed laser beams”, conference contribution “Lasers in Manufacturing Conference 2019”, Wissenschaftliche Gesellschaft Lasertechnik e. V. (WLT), has disclosed using a shaped processing laser beam for hairpin welding, wherein the shaped processing laser beam is generated with a 2-in-1 fiber and has a core portion and a ring portion that annularly surrounds the core portion (BrightLine Weld (2-in-1) fiber technology). A reduction in spatter and pore formation at the beginning and end of the welding was observed.

When using BrightLine Weld (2-in-1) fiber technology, the process time is increased by a factor of 2 to 3 compared to welding with an NIR SingleSpot laser of high brilliance and high intensity under otherwise identical conditions, in particular the same laser power. An increased process time then has to be accepted for the advantage of reducing the process errors.

DE 102016204578 B3 has disclosed a method for laser welding of steel, in which a laser power of a laser beam is modulated in order to avoid the formation of hot cracks when the material of the bar-type conductor solidifies. In one variant, the average laser power during the laser welding of a component increases in an initial phase, remains at a constant, high level during a main phase and then decreases again in an end phase.

### SUMMARY

Embodiments of the present invention provide a method for welding metal-containing bar-type conductors. The method includes arranging at least two bar-type conductors in partially overlapping fashion, and welding the at least two bar-type conductors to one another by using a processing laser beam. A weld bead is formed leading to the bar-type conductors being connected to one another. The processing laser beam, at a workpiece surface, traverses a welding contour relative to the bar-type conductors. The traversing of the welding contour of the at least two bar-type conductors includes an initial phase, a main phase and an end phase. A total power Pₜₒₜ of the processing laser beam in the initial phase, the main phase and the end phase is maintained at least substantially over time. In the initial phase, at least in a partial region of a beam cross section of the processing laser beam at the workpiece surface, an intensity, which is spatially averaged over the partial region, of the processing laser beam is increased over time. In the main phase, at least in the partial region of the beam cross section of the processing laser beam at the workpiece surface, the intensity, which is spatially averaged over the partial region, of the processing laser beam, which is achieved at the end of the initial phase, is kept at least substantially constant over time. In the end phase, at least in the partial region of the beam cross section of the processing laser beam at the workpiece surface, the intensity, which is spatially averaged over the partial region, of the processing laser beam, starting from the intensity at the end of the main phase, is reduced over time.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of two bent bar-type conductors in a partially overlapping arrangement, which are to be welded to one another according to embodiments of the invention;

FIG. 2 shows a schematic oblique view of the end regions, lying against each other, of the two bar-type conductors of FIG. 1, looking at the front end faces, according to some embodiments;

FIG. 3 shows a schematic side view of the end regions of two bar-type conductors welded interconnected by way of a weld bead, with the attachment area being marked, according to some embodiments;

FIG. 4 shows a diagram of the spatially averaged intensity of the processing laser beam at least in a partial region of a cross section of the processing laser beam at the workpiece surface and the total power of the processing laser beam during the laser welding of two bar-type conductors as a function of time, according to some embodiments;

FIG. 5 shows a diagram of the total diameter of the processing laser beam during the laser welding of two bar-type conductors at the workpiece surface as a function of time, in which the intensity change is realized by a change in the diameter of the processing laser beam, according to some embodiments;

FIG. 6a shows a schematic illustration of a reshaped processing laser beam in cross section, with a core portion and a ring portion, in which the intensity change is realized by a change in the power distribution between a core portion and a ring portion of the processing laser beam, according to some embodiments;

FIG. 6b shows a schematic illustration of an exemplary 2-in-1 fiber in cross section, with which a reshaped laser beam for the laser welding according to embodiments of the invention, as shown in FIG. 6a, can be provided, with a core fiber and a ring fiber;

FIG. 7 shows a diagram of the core portion of the laser power of a reshaped processing laser beam during the laser welding of two bar-type conductors as a function of time, for the variant of FIG. 6a, according to some embodiments;

FIG. 8 shows a diagram of the core portion of the laser power of a reshaped processing laser beam during the laser welding of two bar-type conductors as a function of time, with a shorter initial phase, for an alternative variant, in which the intensity change is realized by a change in the power distribution between a core portion and a ring portion of the processing laser beam, according to some embodiments;

FIG. 9a shows the beam cross section of the processing laser beam on the workpiece surface at the beginning or at the end of the laser welding for the variant of FIG. 5 in a schematic top view of the workpiece surface of the two bar-type conductors, according to some embodiments;

FIG. 9b shows the beam cross section of the processing laser beam on the workpiece surface during the main phase of the laser welding for the variant of FIG. 5 in a schematic top view of the workpiece surface of the two bar-type conductors, according to some embodiments; and

FIG. 9c shows the beam cross section of the laser beam reshaped by a 2-in-1 fiber in the initial phase or in the end phase of the laser welding for the variant of FIG. 6a, FIG. 6b and FIG. 7 in a schematic top view of the workpiece surface of the two bar-type conductors, according to some embodiments.

### DETAILED DESCRIPTION

Embodiments of the present invention provide a method for the laser welding of metal-containing bar-type conductors, which allows short process times, and at the same time can produce a good quality of the welding with high reliability.

According to some embodiments, the method is for welding metal-containing, bent bar-type conductors, in particular hairpins for an electric motor or an electric generator. At least two bar-type conductors are arranged in partially overlapping fashion and are welded to one another by means of a processing laser beam. A weld bead is formed, leading to the bar-type conductors being connected to one another. The processing laser beam, at a workpiece surface, traverses a welding contour relative to the bar-type conductors. The traversing of the welding contour of the at least two bar-type conductors includes an initial phase, a main phase and an end phase.

According to some embodiments, a total power Pₜₒₜ of the processing laser beam in the initial phase, the main phase and the end phase is maintained at least substantially over time,

in that, in the initial phase, at least in a partial region, in particular central partial region, of a beam cross section of the processing laser beam at the workpiece surface, an intensity, which is spatially averaged over the partial region, of the processing laser beam is increased over time,

in that, in the main phase, at least in the partial region of the beam cross section of the processing laser beam at the workpiece surface, the intensity, which is spatially averaged over the partial region, of the processing laser beam, which was achieved at the end of the initial phase, is kept at least substantially constant over time,

and in that, in the end phase, at least in the partial region of the beam cross section of the processing laser beam at the workpiece surface, the intensity, which is spatially averaged over the partial region, of the processing laser beam, starting from the intensity at the end of the main phase, is reduced over time.

According to embodiments of the invention, during the welding of the metal-containing bar-type conductors, at least over a partial region, a spatially averaged intensity of the processing laser beam in the partial region of the beam cross section of the processing laser beam at the workpiece surface is varied over time, at a constant total power Pₜₒₜ of the processing laser beam, wherein the intensity increases in an initial phase, is kept constantly high in a main phase, and decreases again in an end phase. As a result, process errors can be reduced or prevented, and at the same time a short process time and also high process stability and process reliability can be achieved. Embodiments of the invention can achieve a temporally rapid and thus cost-efficient welding of good quality and high reliability.

Different process errors may occur during the laser welding of bar-type conductors. At the beginning of the welding, for example, when using an NIR SingleSpot laser of high intensity, a multiplicity of spatters can occur when puncturing the material of the bar-type conductor. This can firstly lead to holes in the weld seam or weld bead, and secondly the spatters can contaminate any surrounding components. For example, in a stator for an electric motor, the individual hairpins are often only a few centimeters apart, which gives rise to the risk that a spatter will strike against other components of the stator, and this in particular can cause short circuits, and the quality of the stator is generally reduced. During the welding, a deep, thin vapor capillary (also called keyhole) may form under the action of the processing laser beam. Said keyhole may collapse in an uncontrolled manner at the end of the welding. As a result, degassing of the evaporated material of the bar-type conductor from the keyhole is no longer possible and, when the molten bar-type conductor material has cooled, the cavity formed in this way remains in the material as a pore. Both the spatters and the pores can reduce the quality of the welding and of the processed workpiece or, in the worst case, can render them unusable.

At the beginning of the initial phase, the “puncturing” by the processing laser beam takes place, and at the end of the end phase, the action of the processing laser beam with the bar-type conductors ends. These two phases are important since spatters and pore formation can occur here. In order to counter said process errors and to obtain welding of good quality, the method according to embodiments of the invention is carried out as described below: in the initial phase, a keyhole can gradually spread into the material of the bar-type conductors in the depth through the increase in intensity at least in the partial region of the beam cross section of the processing laser beam at the workpiece surface. This reduces melt pool dynamics during the puncturing and reduces spatter formation. In the main phase, rapid welding progress can be achieved with high intensity. In the end phase, the keyhole can gradually withdraw from the material of the bar-type conductors out of the depth through the reduction in intensity at least in the partial region of the beam cross section of the processing laser beam at the workpiece surface. In particular, the keyhole does not collapse suddenly; pore formation is thereby minimized. At the same time, it is possible to stabilize the welding process by means of the at least substantially constant total power of the processing laser beam, and to achieve high process reliability, in particular during the puncturing. The total power Pₜₒₜ of the processing laser beam can be selected for the entire laser welding in such a way that, in all the phases of the laser welding of the bar-type conductors, a temporally stable vapor capillary is obtained, and in particular there is no repeated reforming and regression of the vapor capillary. The latter often occurs during the use of simple power ramps in a processing laser beam in time periods of the power ramps of low laser power, and this can be avoided according to embodiments of the invention.

Within the scope of the procedure according to embodiments of the invention, the contradiction between quality of the welding and the process time present in the prior art can be resolved. By means of the intensity variation according to embodiments of the invention, with lower intensity in the initial and end phases, the frequently problematic welding errors therein can be reduced or avoided, and, in the main phase, the process duration overall can be shortened by applying a high, constant intensity and correspondingly higher possible process speed. Good welding quality no longer needs to come at the cost of a long process time and, conversely, a rapid process time no longer needs to come at the cost of losses in quality.

The total power Pₜₒₜ does not change or does not change significantly, e.g. by a maximum of 10% in relation to the (temporal) maximum laser power, during the traversing of the welding contour (for example, a circle repeatedly passed through or an ellipsoid repeatedly passed through).

Typically, at least in the partial region, the spatially averaged intensity is steadily increased in the initial phase and steadily decreased in the end phase. Owing to the constant change in the spatially averaged intensity at least in the partial region in the initial phase and the end phase, low melt pool dynamics can be achieved and thus a pronounced reduction in process errors, such as spatters or pores, can be achieved. The keyhole can increase or decrease uniformly.

In the main phase, at least in the partial region of the beam cross section of the processing laser beam at the workpiece surface, the intensity, which is spatially averaged over the partial region, of the processing laser beam does not change or does not change significantly, e.g. by a maximum of 10% relative to the (temporal) maximum spatially averaged intensity. In the main phase, the welding process can proceed stably.

The processing laser beam has a (spatially) maximum local intensity over its entire beam cross section at a location or in a location range. Said location or location range generally lies within the at least one partial region of the beam cross section of the processing laser beam at the workpiece surface. According to embodiments of the invention, at this location or location range, the (spatially) maximum local intensity is increased over time in the initial phase, is kept at least substantially constant over time in the main phase (e.g. deviation by a maximum of 10% from the maximum temporal value), and is reduced over time in the end phase. By varying the (spatially) maximum local intensity in the initial phase and end phase of the welding, the formation of spatters and pores is reduced or completely prevented. During the main phase, the maximum temporal value of the (spatially) maximum local intensity is reached, thus keeping the process time short.

The terms “(total) power” and “(spatially averaged) intensity” refer to the instantaneous power or the instantaneous intensity for an unmodulated processing laser beam, and to the power or intensity averaged over a modulation period for a modulated processing laser beam. Preferably, an unmodulated processing laser beam is used within the scope of the method, as this allows the process time to be kept shorter and higher process stability is possible.

Typically, two bar-type conductors are welded together according to embodiments of the invention, but welding of three or even more bar-type conductors is also possible; the bar-type conductors to be welded are then connected to one other via a common weld bead. The metal bar-type conductors are usually copper-containing or aluminum-containing bar-type conductors. These bar-type conductor materials are preferably used for the production of electric motors since the current-conducting properties of these materials are favorable.

In a preferred variant of the method according to embodiments of the invention, provision is made that, in the initial phase, a total diameter of the processing laser beam at the workpiece surface is reduced over time, in the main phase the total diameter is kept at least substantially constant over time, and in the end phase is increased over time. By this means, the spatially averaged intensity increases over the entire (decreasing) beam cross section in the initial phase, remains the same over the (constant) entire beam cross section in the main phase, and decreases over the entire (increasing) beam cross section in the end phase. The reduction and increase in the total diameter of the processing laser beam at the workpiece surface can be easily set up, for example by temporally changing the focal position via a simple movement/displacement of a focusing lens. Equipment for further beam shaping, such as a 2-in-1 fiber and a device for power distribution between the partial fibers, is not necessary.

A variant is preferred in which, at least in the initial phase and the end phase, the processing laser beam used is a reshaped laser beam, which comprises a core portion and a ring portion in the beam cross section, wherein the ring portion annularly surrounds the core portion, wherein the total power Pₜₒₜ of the processing laser beam is distributed to the core portion and the ring portion,

in that, in the initial phase, a power portion P_{core} of the total power, which is allotted to the core portion, is increased over time, and a power portion P_{ring} of the total power, which is allotted to the ring portion, is reduced over time,

and in that, in the end phase, the power portion P_{core}, which is allotted to the core portion, is reduced over time, and the power portion P_{ring} of the total power, which is allotted to the ring portion, is increased over time. The core portion then represents the partial region in which the spatially averaged intensity increases in the initial phase, remains constant in the main phase, and becomes smaller in the end phase. By increasing the power portion P_{core}, which is allotted to the core portion, and reducing the power portion P_{ring}, which is allotted to the ring portion, the deepening of the keyhole can be controlled well during the initial phase. In the end phase, by reducing the power portion P_{core}, which is allotted to the core portion, and increasing the power portion P_{ring}, which is allotted to the ring portion, it is possible to achieve the effect that the keyhole formed during the welding can recede in an equally well controlled manner. In general, by dividing the laser power into a core portion and a ring portion during the welding process, the melt pool dynamics can be kept low and a good seam quality can be achieved.

It is advantageous to further develop this variant, which makes provision that, at the beginning of the initial phase: 20%≤P_{core}≤60%, preferably 25%≤P_{core}≤40%, preferably P_{core}=30%,

that, in the main phase: 80%≤P_{core}≤100%, preferably P_{core}=100%,

and that, at the end of the end phase: 20%≤P_{core}≤60%, preferably 25%≤P_{core}≤40%, preferably P_{core}=30%. These power portions P_{core}, which are allotted to the core portion, have proven successful in practice for the method according to embodiments of the invention. The P_{core} values for the initial phase are suitable for being able to form a stable keyhole already at the beginning of the laser welding. Owing to the higher selected power portion P_{core}, good welding efficiency can be achieved in the main phase and the process time can be kept short. In the end phase, the values P_{core} are suitable to the effect that the keyhole can gradually recede and disappears only at the end of the laser welding.

A development is also preferred in which, in the main phase, the power portion P_{core}, which is allotted to the core portion, is 100% and the power portion P_{ring} of the total power, which is allotted to the ring portion, is 0%. This allows maximum efficiency of the welding in the main phase to be achieved and the process time to be kept short.

A development is likewise preferred in which, in the main phase, the power portion P_{core}, which is allotted to the core portion, remains at least substantially constant over time. This enables the process to proceed stably during the main phase. During the main phase, the power portion P_{core}, which is allotted to the core portion, does not change or does not change significantly, e.g. by a maximum of 10% relative to the (temporally) maximum power portion P_{core}, which is allotted to the core portion.

A development is furthermore preferred in which the reshaped laser beam is generated by a 2-in-1 fiber having a core fiber and a ring fiber, having a core fiber diameter KFD where 11 μm≤KFD≤200 μm, preferably 30 μm≤KFD≤100 μm, preferably KFD=50 μm, and having a ring fiber diameter RFD where 30 μm≤RFD≤700 μm, preferably 100 μm≤RFD≤400 μm, preferably RFD=200 μm. With a 2-in-1 fiber, a reshaped laser beam can be easily generated. The core fiber diameter KFD and ring fiber diameter RFD proposed here have proved successful in practice.

In another advantageous variant, in the initial phase and in the end phase, at least in the partial region the spatially averaged intensity is changed linearly over time. By means of the linear change of the spatially averaged intensity in the partial region, calmer melt pool dynamics can be achieved; moreover, a linear change is usually easy to control. In particular in the end phase, the spatially averaged linear change in the intensity in the partial region can cause the keyhole formed during the welding to recede in a well controlled manner, as a result of which the formation of pores can be reduced or prevented.

A variant is also preferred in which the initial phase has a portion of a total welding duration of the traversing of the welding contour of 1% to 30%, preferably 15% to 25%, preferably 20%,

and in that the end phase has a portion of the total welding duration of 1% to 30%, preferably 15% to 25%, preferably 20%. These are portions of the total welding duration of the traversing of the welding contour in the initial phase and end phase that have proven successful in practice and with which the probability of process errors, such as spatters in the initial phase or pores in the end phase, can be minimized. The duration of the initial phase and the duration of the end phase can be selected to be equal, if desired.

In a preferred variant of the method according to embodiments of the invention, provision is made that the processing laser beam is generated with an NIR laser having a wavelength of 800-1200 nm, in particular 1030 nm or 1070 nm. The wavelengths indicated here have proven successful in practice and are suitable for welding hairpins as per the method according to embodiments of the invention. Alternatively, for example, a processing laser beam having a wavelength of 400 nm to 450 nm (blue) or a wavelength of 500 nm to 550 nm (green), in particular approx. 515 nm, can also be used.

A variant is also preferred in which, for the total power Pₜₒₜ of the processing laser beam:

Pₜₒₜ≥4 kW, preferably Pₜₒₜ≥6 kW. The total powers Pₜₒₜ shown here for the processing laser beam are total powers Pₜₒₜ which have proven successful in practice and which can be used to reliably generate a keyhole that is stable over time. Typically, 4 kW≤Pₜₒₜ≤8 kW. A higher total power Pₜₒₜ generally results in a shorter process time.

A variant is preferred in which the processing laser beam has a beam parameter product SPP, where SPP≤4 mm*mrad. The beam parameter product SPP generally describes the beam quality of a laser beam. For the method according to embodiments of the invention, it has proven successful in practice to use a processing laser beam having such a beam parameter product SPP.

In an advantageous variant, the processing laser beam at the workpiece surface has a maximum diameter Dₘₐₓ, where 71 μm≤Dₘₐₓ≤1360 μm, preferably 250 μm≤Dₘₐₓ≤450 μm, preferably Dₘₐₓ=340 μm. These maximum diameters Dₘₐₓ of the processing laser beam at the workpiece surface have proven successful in practice for the method according to embodiments of the invention. The maximum diameter corresponds to the (largest) diameter of the ring portion in the case of a reshaped laser beam, which has a core portion and a ring portion in the beam cross section. It is also preferred if the processing laser beam at the workpiece surface has a minimum diameter Dₘᵢₙ, where 30 μm≤Dₘᵢₙ≤340 μm, preferably 50 μm≤Dₘᵢₙ≤150 μm, preferably Dₘᵢₙ=84 μm. This has also proven successful in practice. The minimum diameter of the processing laser beam corresponds to the (largest) diameter of the core portion in the case of a reshaped laser beam, which has a core portion and a ring portion in the beam cross section and has a power portion P_{core}=100% in the main phase. The diameters can be determined according to FWHM (full width at half maximum).

A bar-type conductor arrangement comprising at least two bar-type conductors, welded by an above-described method according to embodiments of the invention, is also covered within the embodiments of the present invention. The bar-type conductor arrangement can be produced reliably with high quality and cost-efficiently by means of the method according to embodiments of the invention. The weld bead formed during the welding is uniformly shaped and reliably provides a sufficient cross-sectional area for the electrical current flow between the welded bar-type conductors. Typically, a multiplicity of bar-type conductors are welded consecutively (for example in a stator carrier), with the bar-type conductors being welded at both legs to further bar-type conductors (or, in the case of terminal bar-type conductors, to a power connection).

Furthermore, embodiments of the present invention include the use of bar-type conductor arrangements, wherein the bar-type conductor arrangements are each produced by welding at least two bar-type conductors by an above-described method according to embodiments of the invention, wherein the bar-type conductor arrangements are installed in an electric motor or an electric generator. The welding of the bar-type conductors is reliable and therefore also readily suitable for the high current strengths occurring in electric motors and electric generators. The high-quality welding is readily suitable for continuous loads, as occur in road traffic with electric motors in electric vehicles.

Further advantages of the embodiments of the invention are evident from the description and the drawing. Likewise, according to embodiments of the invention, the features mentioned above and those that will be explained still further can be used in each case individually by themselves or as a plurality in any desired combination. The embodiments shown and described should not be understood as an exhaustive enumeration, but rather are of an exemplary character for outlining the embodiments of the invention.

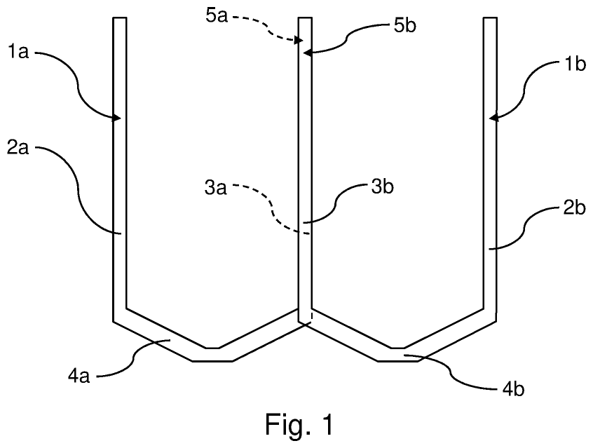

FIG. 1 shows a schematic side view of, by way of example, two metal-containing, bent bar-type conductors 1a, 1b. The bar-type conductors 1a, 1b are designed as what are referred to as hairpins, which are used for the production of an electrodynamic machine, such as an electric motor or an electric generator. The bar-type conductors 1a, 1b are each approximately U-shaped and each have two legs 2a, 3a and 2b, 3b and a central part 4a, 4b, which connects the respective leg pairs to each other.

The bar-type conductors 1a, 1b are intended to be electrically conductively connected to each other. For this purpose, according to embodiments of the invention, the bar-type conductors 1a, 1b are welded together at their end regions 5a, 5b. For the welding, the leg 3a of the first bar-type conductor 1a and the leg 3b of the second bar-type conductor 1b are arranged overlapping and, in the variant shown here, lying against each other.

For the bar-type conductors 1a, 1b, typically copper-based or aluminum-based materials are used as bar-type conductor materials.

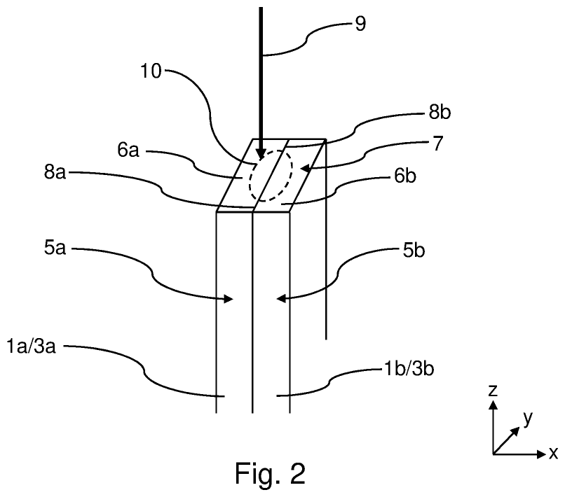

FIG. 2 shows a schematic oblique view of the end regions 5a, 5b, lying against each other, of the two bar-type conductors 1a, 1b of FIG. 1a. The coordinate system is selected such that the x axis points to the right, the y axis points into the plane of the drawing, and the z axis points upward. The front end faces 6a, 6b of the two bar-type conductors 1a, 1b form a common workpiece surface 7 and have been arranged at approximately the same height. The long sides 8a, 8b of the end regions 5a, 5b of the legs 3a, 3b lie flat and flush against each other, the legs 3a, 3b being pressed against each other in a manner which is not illustrated specifically. The legs 3a, 3b are oriented parallel to each another and vertically such that the workpiece surface 7 is oriented upward.

For the welding of the two end regions 5a, 5b, use is made of a processing laser beam 9 which traverses a welding contour 10 on the workpiece surface 7, here on a repetitive, elliptical trajectory. Alternatively, it is possible, for example, that the processing laser beam 9 also traverses it on a circular trajectory or along a line (not shown here). The processing laser beam 9 strikes against the workpiece surface 7 approximately perpendicularly. It should be noted that, during the manufacture of different pairs of bar-type conductors 1a, 1b, the angle of incidence of the processing laser beam 9 can typically vary slightly in order not to have to move the bar-type conductors 1a, 1b, which are usually arranged in a stator carrier (not shown in detail), too frequently. The processing laser beam 9 typically does not deviate more than 40°, preferably not more than 20°, from a vertical incidence on the workpiece surface 7.

As a result of the action of the processing laser beam 9, the material of the bar-type conductors 1a, 1b fuses in the vicinity of the workpiece surface 7, and a weld bead forms. The processing laser beam 9 can be generated with an NIR laser having a wavelength of between 800 nm and 1200 nm, in particular having a wavelength of 1030 nm or 1070 nm. The total power Pₜₒₜ of the processing laser beam 9 is typically 4 kW≤Pₜₒₜ≤8 kW and can be selected such that Pₜₒₜ≥4 kW, preferably Pₜₒₜ≥6 kW. In addition, it has been shown that it may be advantageous if the processing laser beam 9 has a beam parameter product SPP, where SPP≤4 mm*rad, and the NIR laser has a fiber diameter DF, where DF≤100 μm.

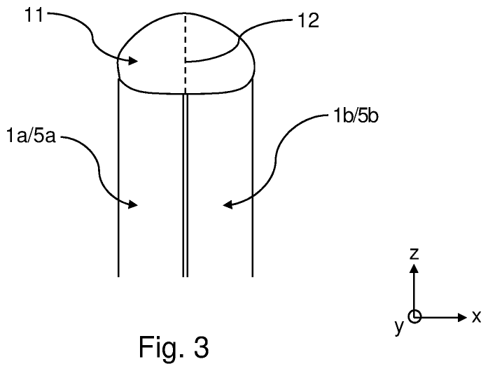

FIG. 3 shows the end regions 5a, 5b of the bar-type conductors 1a, 1b after the welding. The coordinate system is selected such that the x axis points to the right, the y axis points into the plane of the drawing, and the z axis points upward. The bar-type conductors 1a, 1b are electrically conductively interconnected by way of the weld bead 11. The weld bead 11 sits entirely on the two bar-type conductors 1a, 1b.

The quality of the electrically conductive connection between the two bar-type conductors 1a, 1b is substantially determined by the quality of the weld bead 11 and an attachment area 12. The attachment area 12 is the cross-sectional area which is provided by the weld bead 11 for an electrical conduction of current from the first bar-type conductor 1a to the second bar-type conductor 1b.

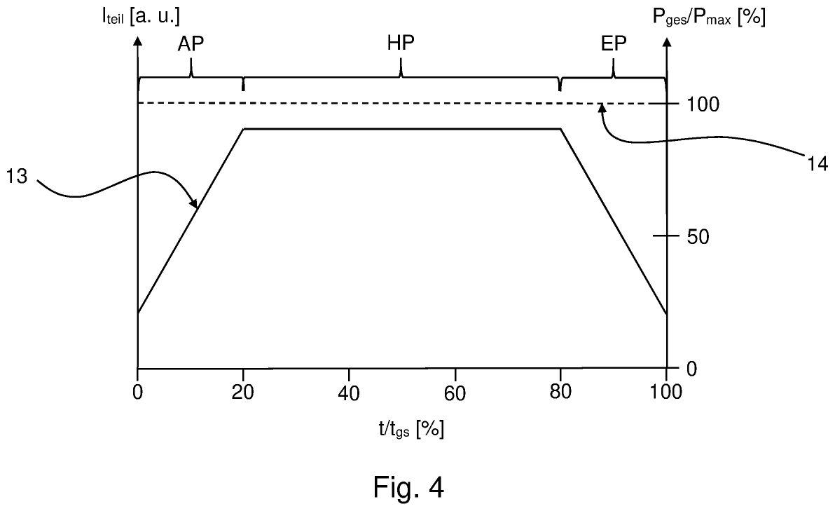

FIG. 4 shows a diagram of the laser welding according to an embodiment of the invention, in which an intensity Iₚₐᵣₜ, which is spatially averaged over at least a partial region, in particular a central partial region, of the processing laser beam and a total power Pₜₒₜ of the processing laser beam during the welding of two bar-type conductors are illustrated as a function of time. The left ordinate shows the intensity Iₚₐᵣₜ in arbitrary units (a.u.), the right ordinate represents the total power Pₜₒₜ of the processing laser beam as a portion of a maximum laser power Pₘₐₓ applied during the laser welding in %. The time t is displayed on the abscissa as a portion of the total welding duration t_{wd} in %. The solid line 13 shows the course of the intensity Iₚₐᵣₜ, which is spatially averaged at least over the partial region. The dashed line 14 shows the course of the total power Pₜₒₜ of the processing laser beam. In the exemplary embodiment of the invention, the procedure is as follows:

the welding of the two bar-type conductors comprises an initial phase AP, a main phase HP and an end phase EP. During these phases, the welding contour is traversed (with, for example, an elliptical trajectory or circular trajectory being passed along repeatedly). An advancing rate can be selected here to be constant over the total welding duration t_{wd}. In the initial phase AP (here between 0% and 20% of the total welding time t_{wd}) and in the end phase EP (here between 80% and 100% of the total welding duration t_{wd}) of the laser welding of the bar-type conductors, an intensity Iₚₐᵣₜ, which is spatially averaged at least over the partial region, of the processing laser beam in the beam cross section of the processing laser beam at the workpiece surface is selected to be lower than in the intermediate main phase HP (here between 20% and 80% of the total welding duration t_{wd}).

In the “puncturing” by the processing laser beam at the beginning of the initial phase AP (at 0% of the total welding duration t_{wd}), the formation of spatters is reduced by the lower intensity Iₚₐᵣₜ, which is spatially averaged at least over the partial region, of the processing laser beam. The intensity Iₚₐᵣₜ, which is spatially averaged at least over the partial region, starts here at a desired, initial value and then increases in the initial phase AP (here linearly) until it has reached a desired value for the main phase HP. The initial value of the intensity Iₚₐᵣₜ is usually between 20% and 60% of the maximum intensity Iₚₐᵣₜ applied (during the main phase). During the initial phase AP, the depth of the vapor capillary gradually increases as the intensity Iₚₐᵣₜ increases. The selection of the duration of the initial phase AP can be based, for example, on the fact that the vapor capillary produced by the processing laser beam has reached a certain capillary depth (e.g. 30% of its maximum capillary depth; usually, at the end of the initial phase, a capillary depth of between 20% and 45% of the maximum capillary depth is reached). The initial phase AP often comprises a portion of 1% to 30%, preferably 15% to 25%, preferably 20% (as shown in FIG. 4 here) of the total welding duration t_{wd} and can last between 1 ms and 30 ms, for example, and longer durations of the initial phase (longer than 30 ms) can also be considered for larger hairpins (for example for truck engines).

In the main phase HP (here between 20% and 80% of the total welding duration t_{wd}), the welding contour then continues to be traversed with the desired intensity Iₚₐᵣₜ, which is spatially averaged at least over the partial region, of the processing laser beam. During the application of the constant, maximum intensity Iₚₐᵣₜ in the main phase HP, a further deepening of the vapor capillary may occur.

After the main phase HP (here from 80% of the total welding duration t_{wd}), the intensity Iₚₐᵣₜ, which is spatially averaged over the partial region, of the processing laser beam is reduced again (here linearly) until it reaches a desired, final value (which corresponds here to the initial value at the beginning of the initial phase AP). The final value of the intensity Iₚₐᵣₜ is usually between 20% and 60% of the maximum intensity Iₚₐᵣₜ applied (during the main phase). By reducing the intensity Iₚₐᵣₜ in the end phase EP, the effect is achieved that the vapor capillary produced by the processing laser beam uniformly recedes, as a result of which only few pores, if any at all, are obtained in the cooled bar-type conductor material. The end phase EP of the welding is 20% here of the total welding duration t_{wd} of the bar-type conductors. The end phase EP often comprises a portion of 1% to 30%, preferably 15% to 25%, preferably 20% (as shown in FIG. 4 here) of the total welding duration t_{wd}, and can, for example, last between 1 ms and 30 ms.

The change in the intensity Iₚₐᵣₜ, which is spatially averaged at least over the partial region, of the processing laser beam is selected to be linear here, as this can usually be more easily controlled. In addition, a linear change can provide calmer melt pool dynamics during the welding. Similarly, the process stability can thereby be improved and, in particular in the end phase, the keyhole formed during the welding can recede in a readily controlled manner, as a result of which the formation of pores can be reduced or prevented.

While the intensity Iₚₐᵣₜ, which is spatially averaged at least over the partial region, of the processing laser beam changes over time, the total power Pₜₒₜ of the processing laser beam remains substantially constant throughout the entire time and, in this example, is 100% of the maximum total power Pₘₐₓ. Owing to this substantially constant total power Pₜₒₜ, high process reliability can be achieved, in particular in the initial phase AP during and shortly after the puncturing by the processing laser beam, and high process stability can be maintained overall during the welding.

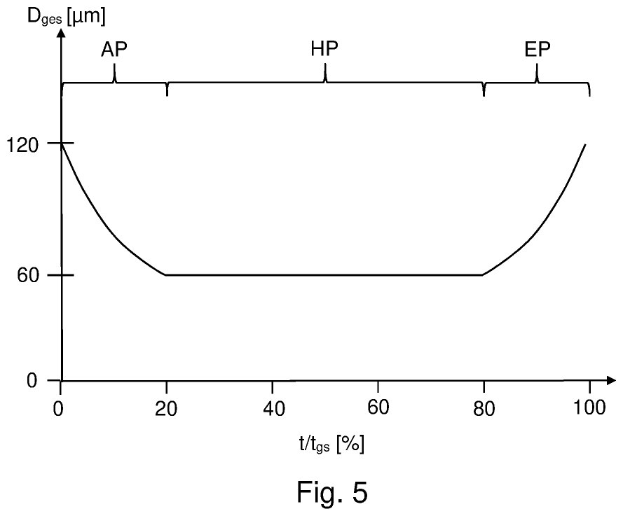

FIG. 5 shows a diagram for an embodiment of the invention, in which the intensity change illustrated in FIG. 4 is realized by a change in diameter of the processing laser beam. The total diameter Dₜₒₜ of the processing laser beam at the workpiece surface during the welding of two bar-type conductors is shown as a function of time. The ordinate displays the total diameter Dₜₒₜ of the processing laser beam at the workpiece surface in μm. The time t is displayed on the abscissa as a portion of the total welding duration t_{wd} in %.

To increase the intensity Iₚₐᵣₜ, which is spatially averaged at least over the partial region, of the processing laser beam in the initial phase AP (between 0% and 20% of the total welding duration t_{wd}), as has been shown in FIG. 4, the total diameter Dₜₒₜ of the processing laser beam at the workpiece surface in the form shown here is reduced over time from 120 μm to 60 μm. If the shape of the processing laser beam is circular, the change in the total diameter Dₜₒₜ can be carried out, for example, proportionally to t^{-1/2} (shown here schematically) in order to obtain a linear increase in the intensity Iₚₐᵣₜ, which is spatially averaged at least over the partial region, of the processing laser beam (see FIG. 4). It has been noted that, in this variant, the intensity Iₚₐᵣₜ is spatially averaged over the entire beam diameter at a particular instance.

During the main phase HP (here between 20% and 80% of the total welding duration t_{wd}), the total diameter Dₜₒₜ is kept substantially constant at a value of 60 μm. Thus, in the form shown here, the maximum intensity of the intensity Iₚₐᵣₜ, which is spatially averaged at least over the partial region, of the processing laser beam (which corresponds here to the spatially averaged intensity of the total beam cross section) can be obtained in the main phase HP.

To reduce the intensity Iₚₐᵣₜ, which is spatially averaged at least over the partial region, of the processing laser beam in the end phase EP (between 80% and 100% of the total welding duration t_{wd}), as has been shown in FIG. 4, the total diameter Dₜₒₜ of the processing laser beam at the workpiece surface in the form shown here is increased over time from 60 μm to 120 μm. Here, too, the change in the total diameter Dₜₒₜ can be carried out, for example, proportionally to t^{-1/2} (shown here schematically) in order to obtain a linear reduction in the intensity Iₚₐᵣₜ, which is spatially averaged at least over the partial region, of the processing laser beam (see FIG. 4).

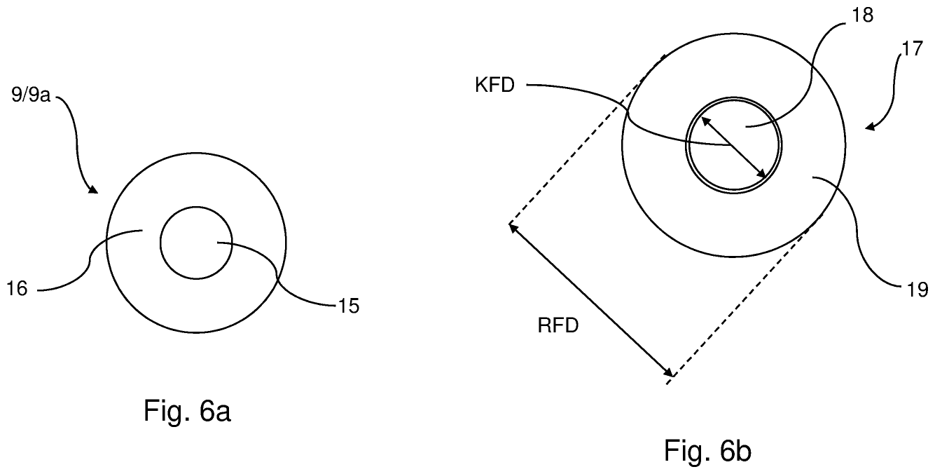

Within the context of the method according to embodiments of the invention, it is advantageous to select the processing laser beam 9 as a reshaped laser beam 9a, which at least temporarily has a core portion 15 and a ring portion 16. FIG. 6a shows an example of a beam cross section of such a reshaped laser beam 9a. The ring portion 16 surrounds the core portion 15. This allows welding errors to be reduced, in particular at the beginning of the laser welding and at the end of the laser welding.

The reshaped laser beam 9a is generated, for example, by a 2-in-1 fiber 17; FIG. 6b shows an example of a cross section of the 2-in-1 fiber 17, with which a reshaped laser beam for the method according to embodiments of the invention can be provided, as shown in FIG. 6a. The 2-in-1 fiber 17 has a core fiber 18 and a ring fiber 19 surrounding the latter. For the core fiber diameter KFD of such a 2-in-1 fiber 17, it is possible to select, for example, 11 μm≤KFD≤200 μm, preferably 30 μm≤KFD≤100 μm, preferably KFD=50 μm, and, for the ring fiber diameter RFD of such a 2-in-1 fiber 17, it is possible to select, for example, 30 μm≤RFD≤700 μm, preferably 100 μm≤RFD≤400 μm, preferably RFD=200 μm. In most cases, 2.5≤RFD/KFD≤7.5, and in particular often RFD/KFD=4.

A power portion P_{core}, which is allotted to the core portion, and a power portion P_{ring}, which is allotted to the ring portion, can be adjusted by the fact that an original laser beam is partially fed into the core fiber 18 and partially into the ring fiber 19, for example via an optical wedge (not shown specifically) partially inserted into the original laser beam. Within the embodiments of the invention, the intensity Iₚₐᵣₜ, which is spatially averaged over the partial region, can be varied over time in a partial region, namely in the centrally located core portion, of the beam cross section of the processing laser beam at the workpiece surface. At the beginning of the initial phase, the power portion P_{core}, which is allotted to the core portion, can be selected to be 20%≤P_{core}≤60%, preferably 25%≤P_{core}≤40%, preferably P_{core}=30% of the total power Pₜₒₜ of the processing laser beam. In the main phase, the power portion P_{core}, which is allotted to the core portion, can be selected to be 80%≤P_{core}≤100%, preferably P_{core}=100% of the total power Pₜₒₜ of the processing laser beam. At the end of the end phase, the power portion P_{core}, which is allotted to the core portion, can be selected to be 20%≤P_{core}≤60%, preferably 25%≤P_{core}≤40%, preferably P_{core}=30% of the total power Pₜₒₜ of the processing laser beam. The total laser power Pₜₒₜ=P_{core}+P_{ring} is selected to be at least substantially constant over the total welding duration.

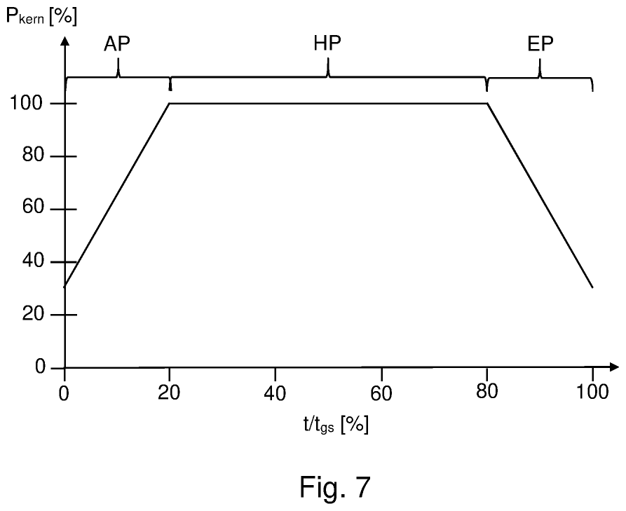

FIG. 7 shows a diagram, in which the power portion P_{core} of the constant total power Pₜₒₜ during the welding of two bar-type conductors is shown as a function of time, for the variant of FIG. 6a. The ordinate displays the power portion P_{core} of the total power Pₜₒₜ of the processing laser beam in %. The time t is displayed on the abscissa as a portion of the total welding duration t_{wd} in %. The procedure is as follows: the laser welding of the two bar-type conductors is basically as shown in FIG. 4 and

comprises the initial phase AP, the main phase HP and the end phase EP, during which the welding contour is traversed. The advancing rate can be selected here to be constant over the total welding duration t_{wd}. In the initial phase AP (here between 0% and 20% of the total welding duration t_{wd}) and in the end phase EP (here between 80% and 100% of the total welding duration t_{wd}) of the laser welding of the bar-type conductors, the power portion P_{core} is selected to be lower than in the intermediate main phase HP (here between 20% and 80% of the total welding duration t_{wd}).

Upon puncturing by the reshaped laser beam at the beginning of the initial phase AP (at 0% of the total welding duration t_{wd}), the formation of spatters is reduced by the lower power portion P_{core}. The power portion P_{core} starts here at 30% and then increases in the initial phase AP (here linearly) until it has reached a desired value for the main phase HP. For example, the selection of the duration of the initial phase may depend on whether the vapor capillary produced by the reshaped laser beam has reached a certain capillary depth (e.g. 30% of its maximum capillary depth).

In the main phase HP (here between 20% and 80% of the total welding duration t_{wd}), the welding contour then continues to be traversed with the desired power portion P_{core}. In the variant shown, the power portion P_{core} in the main phase is 100%, i.e. the ring portion is not illuminated.

After the main phase HP (here from 80% of the total welding duration t_{wd}), the power portion P_{core} is reduced again (here linearly) until it reaches a desired value (here in turn 30%). The effect achieved by this is that the vapor capillary produced by the reshaped laser beam uniformly recedes, as a result of which only few pores, if any at all, are obtained in the cooled bar-type conductor material. The end phase EP of the welding is 20% here of the total welding duration La of the traversing of the welding contour of the bar-type conductors.

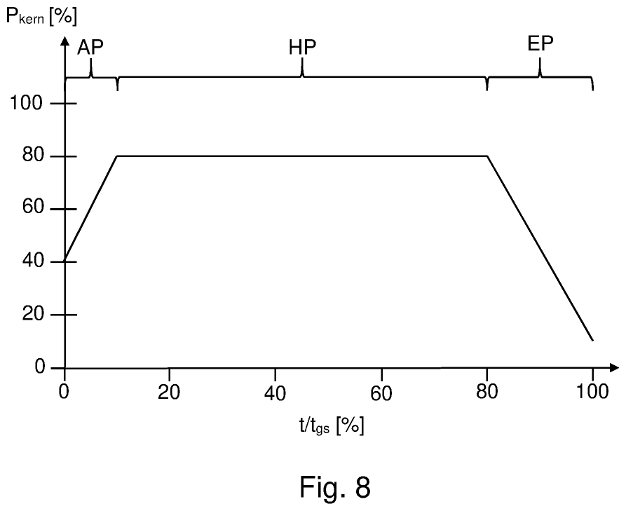

FIG. 8 shows a diagram of an advantageous variant of the method according to embodiments of the invention similar to that described in FIG. 7, wherein the duration of the initial phase AP and the main phase HP and also the temporal course of the power portion P_{core} differ. Only the substantial changes will be discussed. The ordinate displays the power portion P_{core} of the total power Pₜₒₜ of the processing laser beam in %. The time t is displayed on the abscissa as a portion of the total welding duration t_{wd} in %.

Upon puncturing by the reshaped laser beam at the start of the initial phase AP (at 0% of the total welding duration t_{wd}), 40% is selected here for the power portion P_{core}. Furthermore, the duration of the initial phase AP of the welding in this variant is selected merely to be 10% of the total welding duration t_{wd} of the traversing of the welding contour of the bar-type conductors. During the initial phase AP, the power portion P_{core} increases to 80% here. By reducing the initial phase AP, a faster transition to the main phase HP can be achieved, with the higher initial power portion P_{core} of 40% and the lower maximum power portion P_{core} at 80% being able to keep the gradient of the power portion P_{core} of the core portion moderate in the initial phase AP. The latter helps to limit the melt pool dynamics.

In the main HP phase (here between 10% and 80% of the total welding duration t_{wd}), the welding contour then continues to be traversed with the desired power portion P_{core}. In the variant shown, the power portion P_{core} in the main phase is 80%, i.e. the power portion P_{ring} continues to be illuminated to 20%. As a result, a good compromise can still be reached between good welding quality on the one hand and short process time on the other.

After the main phase HP (here from 80% of the total welding duration Gm), the power portion P_{core} is reduced again (here linearly) until it reaches a value of only 10% here. The effect achieved by this is that the vapor capillary is already small at the end of the end phase EP, i.e. at the end of the action of the processing laser beam, before it disappears completely as a result of switching off of the energy input by the laser. This can further reduce the formation of pores. The end phase EP of the welding is 20% here of the total welding duration t_{wd} of the traversing of the welding contour of the bar-type conductors.

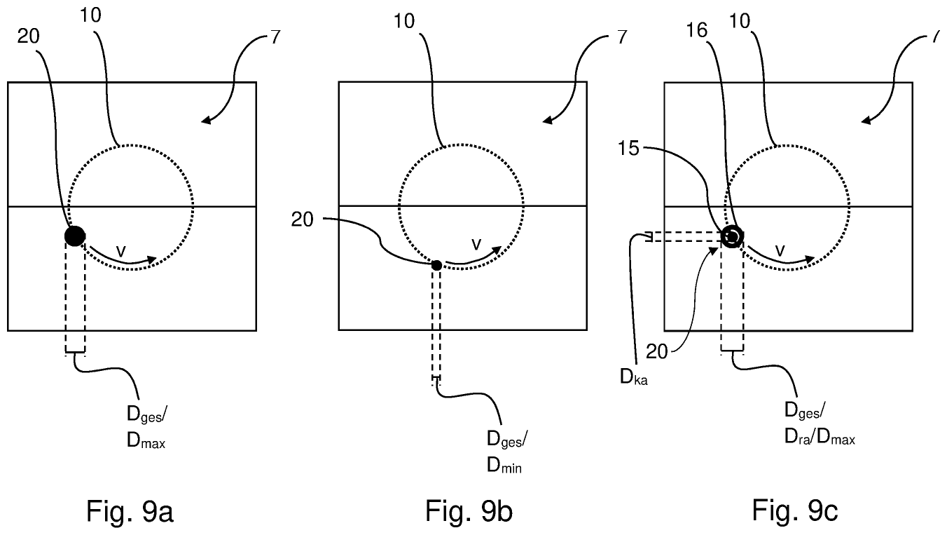

FIG. 9a shows a schematic top view of the workpiece surface 7 of the two bar-type conductors for the variant of FIG. 5, wherein the beam cross section 20 of the processing laser beam on the workpiece surface 7 is shown. The total diameter Dₜₒₜ of the beam cross section is variable in the variant of FIG. 5 and shown in FIG. 9a at the beginning of the initial phase or at the end of the end phase of the laser welding, wherein the maximum diameter Dₘₐₓ is present.

The beam cross section 20 on the workpiece surface 7 is directed at the circular welding contour 10 here and is moved along the welding contour 10 at the advancing rate v (e.g. where v=600 mm/s). For the maximum diameter Dₘₐₓ of the processing laser beam at the workpiece surface 7, it is possible, for example, to select 30 μm≤Dₘₐₓ≤340 μm, preferably 50 μm≤Dₘₐₓ≤150 μm, preferably Dₘₐₓ=84 μm.

FIG. 9b shows the schematic top view from FIG. 9a, wherein now the total diameter Dₜₒₜ of the beam cross section 20 at the workpiece surface 7 has been reduced to the minimum diameter Dₘᵢₙ during the welding process, which corresponds to the situation during the main phase. By reducing the beam cross section 20, the intensity, which is spatially averaged over the beam cross section 20, of the processing laser beam can be increased (while maintaining the total laser power).

FIG. 9c schematically shows the beam cross section 20 of the reshaped laser beam generated by a 2-in-1 fiber in the initial phase or in the end phase of the laser welding for the variant of FIGS. 6a/6b/7 in a schematic top view of the workpiece surface 7. The core portion has an (outer) diameter D_{cp} and the ring portion 16 has an (outer) diameter Dᵣₚ. The diameter D_{cp} simultaneously represents the maximum diameter Dₘₐₓ of the beam cross section 20. The reshaped laser beam is moved along the circular welding contour 10 at the advancing rate v (e.g. where v=600 mm/s).

During the initial phase, the power portion P_{core}, which is allotted to the core portion, is increased and the power portion P_{ring}, which is allotted to the ring portion, is reduced. In the case that the power portion P_{core} during the main phase is 100%, a situation similar to that shown in FIG. 9b then results. At the end of the main phase, the power portion P_{core} is reduced and the power portion P ring is increased, as a result of which again the initial position as shown in FIG. 9c is obtained.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1a, 1b Bar-type conductor
2a, 2b (Outer) leg
3a, 3b (Inner) leg
4a, 4b Central part
5b End region
6a, 6b Front end face
7 Workpiece surface
8a, 8b Long sides
9 Processing laser beam
9a Reshaped laser beam
10 Welding contour
11 Weld bead
12 Attachment area
13 Solid line Iₚₐᵣₜ
14 Dashed line Pₜₒₜ
15 Core portion
16 Ring portion
17 2-in-1 fiber
18 Core fiber
19 Ring fiber
20 Beam cross section (on the workpiece surface)
AP Initial phase
Dₜₒₜ Total diameter
D_{cp} Diameter core portion
Dₘₐₓ Maximum total diameter
Dₘᵢₙ Minimum total diameter
Dᵣₚ Diameter ring portion
EP End phase
HP Main phase
Iₚₐᵣₜ Intensity, which is spatially averaged at least over the partial region
KFD Core fiber diameter
Pₜₒₜ Total power of the processing laser beam
P_{core} Power portion which is allotted to the core portion
P_{ring} Power portion which is allotted to the ring portion
RFD Ring fiber diameter
t Time
t_{wd} Total welding duration
v Advancing rate

1. A method for welding metal-containing bar-type conductors, the method comprising:
arranging at least two bar-type conductors in partially overlapping fashion, and
welding the at least two bar-type conductors to one another by using a processing laser beam,
wherein a weld bead is formed leading to the bar-type conductors being connected to one another,
wherein the processing laser beam, at a workpiece surface, traverses a welding contour relative to the bar-type conductors,
wherein the traversing of the welding contour of the at least two bar-type conductors comprises an initial phase, a main phase and an end phase,
wherein a total power Pₜₒₜ of the processing laser beam in the initial phase, the main phase and the end phase is maintained at least substantially over time,
wherein, in the initial phase, at least in a partial region of a beam cross section of the processing laser beam at the workpiece surface, an intensity of the processing laser beam, which is spatially averaged over the partial region, is increased over time,
wherein, in the main phase, at least in the partial region of the beam cross section of the processing laser beam at the workpiece surface, the intensity of the processing laser beam, which is spatially averaged over the partial region, which is achieved at the end of the initial phase, is kept at least substantially constant over time, and
wherein, in the end phase, at least in the partial region of the beam cross section of the processing laser beam at the workpiece surface, the intensity of the processing laser beam, which is spatially averaged over the partial region, starting from the intensity at the end of the main phase, is reduced over time.

2. The method as claimed in claim 1, wherein, in the initial phase, a total diameter of the processing laser beam at the workpiece surface is reduced over time; in the main phase, the total diameter is kept at least substantially constant over time; and in the end phase, the total diameter is increased over time.

3. The method as claimed in claim 1,
wherein at least in the initial phase and the end phase, the processing laser beam is a reshaped laser beam that comprises a core portion and a ring portion in the beam cross section, wherein the ring portion annularly surrounds the core portion, wherein the total power Pₜₒₜ of the processing laser beam is distributed to the core portion and the ring portion,
wherein, in the initial phase, a power portion P_{core} of the total power, which is allotted to the core portion, is increased over time, and a power portion P_{ring} of the total power, which is allotted to the ring portion, is reduced over time,
and wherein, in the end phase, the power portion P_{core}, which is allotted to the core portion, is reduced over time, and the power portion P_{ring} of the total power, which is allotted to the ring portion, is increased over time.

4. The method as claimed in claim 3, wherein, at a beginning of the initial phase: 20%≤P_{core}≤60%,
wherein, in the main phase: 80%≤P_{core}≤100%, and
at an end of the end phase: 20%≤P_{core}≤60%.

5. The method as claimed in claim 3, wherein, in the main phase, the power portion P_{core}, which is allotted to the core portion, is 100%, and the power portion P_{ring}, which is allotted to the ring portion, is 0%.

6. The method as claimed in claim 3, wherein, in the main phase, the power portion P_{core}, which is allotted to the core portion, remains at least substantially constant over time.

7. The method as claimed in claim 3, wherein the reshaped laser beam is generated by a 2-in-1 fiber having a core fiber and a ring fiber, having a core fiber diameter KFD, where 11 μm≤KFD≤200 μm, and having a ring fiber diameter RFD, where 30 μm≤RFD≤700 μm.

8. The method as claimed in claim 1, wherein, in the initial phase and in the end phase, at least in the partial region, the spatially averaged intensity is changed linearly over time.

9. The method as claimed in claim 1,
wherein the initial phase has a first portion of a total welding duration of the traversing of the welding contour of 1% to 30%, and
wherein the end phase has a second portion of the total welding duration of 1% to 30%.

10. The method as claimed in claim 1, wherein
the processing laser beam is generated with a near infrared (NIR) laser having a wavelength of 800-1200 nm.

11. The method as claimed in claim 1, wherein, for the total power Pₜₒₜ of the processing laser beam: Pₜₒₜ≥4 kW.

12. The method as claimed in claim 1, wherein the processing laser beam has a beam parameter product SPP, where SPP≤4 mm*mrad.

13. The method as claimed in claim 1, wherein the processing laser beam, at the workpiece surface, has a maximum diameter Dₘₐₓ, where 71 μm≤Dₘₐₓ≤1360 μm.

14. A bar-type conductor arrangement comprising at least two bar-type conductors, welded by the method as claimed in claim 1.

15. The method as claimed in claim 1, wherein the at least two bar-type conductors, after being welded to one another, are installed in an electric motor or an electric generator.
